(19) United States
(12) Patent Application Publication
(10) Pub. No.: US 2011/0164915 A1
(43) Pub. Date: Jul. 7, 2011

(54) Capsule Magnet Pen Tip and Magnet Pen

(75) Inventor: LAI TANG WYLER WONG, Hong Kong (HK)

(73) Assignee: MARKETA INTERNATIONAL LTD., HONG KONG (HK)

(21) Appl. No.: 12/651,488

(22) Filed: Jan. 4, 2010

(51) Int. Cl. B43K 29/00

(52) U.S. Cl. 401/195

(57) ABSTRACT

A capsule magnet pen tip according to the present invention comprises a magnet and a cover, wherein the magnet is assembled inside the cover. The present invention also comprises with a magnet pen which includes a pen tip and a pen shaft, of which the pen tip used is same as the capsule magnet pen tip. The present invention uses lead-free or low-lead environmental material to avoid lead poisoning and pollution. The magnet has contact with the part of the inverted triangle-shaped and the inner-cylinder of the cover only; so it is more protective of the magnet. The semi-spherical pen tip reduces attrition with the drawing board, and also reduces the risk of poke to children. Thus, the present invention can greatly improve the safety of the article and protection of the environment as well as the value of the article. The magnet pen tip is the accessory of the magnet drawing board. It can be widely used as children's educational toys and drawings articles and thus the requirement of the safety standards is especially high. The present invention provides an improvement of the drawback of the conventional technologies, wherein the magnet is exposed. It provides a more safety pen tip with more clearly writing.

### FIELD OF TECHNOLOGY

The present invention relates to a stationery accessory, and more particularly, a capsule magnet pen tip for magnet pen use on magnet drawing board, and a magnet pen with that capsule magnet pen tip.

### BACKGROUND OF THE INVENTION

Magnet drawing board is a kind of dust-free writing instruments. Due to its low price and can re-use, it is particularly suitable for writing exercises and development of children. It can be widely used as children's educational toys, teaching tools or message boards, etc. As the drawing board is especially for children's use, the safety standards of the magnet pen are very high. In conventional technologies, the magnet pen tip is comprised of a copper cover, of which the magnet is assembled in that copper cover and the magnet is exposed. However, as the magnet is exposed, it can be easily loosed and swallowed by children as its size is very small. Further, it is not environment protection as the lead burden of the copper cover is high. During the mounting process of the copper cover with the magnet, it is required to add the lead to the copper in order to adjust its hardness for cutting. In addition, children have hazarded habit to bite anything and their immunity is imperfect. Thus, the conventional technologies of the magnet tip are dangerous to children. Besides, the disposal of lead material will pollute the soil and water seriously.

### SUMMARY OF THE UTILITY MODEL

In order to solve the aforesaid problem, the present invention proposed a capsule magnet pen tip for enhancement.

A capsule magnet pen tip according to the present invention comprises a magnet and a cover, characterized in that the magnet is assembled inside the cover.

Advantageously, it also includes a seal of metal particle or silicone particle, wherein the seal of metal particle or silicone particle is located inside the cover. The front of the sealed cover acts as the pen tip and the seal of metal particle or silicone particle is fit with the cover and thus to force the magnet stay at the front of the cover.

Advantageously, the interior of the cover is cylindrical and hollow; wherein the magnet and the seal of metal particle or silicone particle are joined together as cylinder with inverted triangle-shaped process.

Advantageously, the front pen tip of the cover is conical.

Advantageously, the junction of the pen shaft and the cover is processed with inverted triangle-shaped.

Advantageously, the diameter of the magnet is shorter than the diameter of the seal of metal particle or silicone particle.

Advantageously, the exterior of the cover is curved.

Advantageously, the material used for the cover is Pb<40 ppm environmental copper material or SUS304L stainless (Pb=0 ppm).

Advantageously, the material used for the seal of particle is Pb<40 ppm environmental copper material or SUS304L stainless (Pb=0 ppm) metal or silicone.

The present invention also provides an improved magnet pen with higher safety.

A magnet pen, comprised with pen tip and shaft; wherein the magnet is assembled inside the cover of the pen tip and there is a trough inside the pen shaft to allow the pen tip mounted with.

The present invention provides a capsule magnet pen tip, wherein the magnet is assembled inside the cover. The magnet is covered and will not loose and absolutely safety for children.

The diameter of the magnet is shorter than the inner-diameter of the cover. The magnet has contact with the part of the inverted triangle-shaped and the inner-cylinder of the cover; so it is more protective of the magnet; and avoids damage of magnet from deformed cover.

The semi-spherical pen tip reduces attrition with the drawing board, and also reduces the risk of poke to children.

The described pen shaft has a trough and allows the pen tip to be mounted with very firmly, not be easily loosed.

### EXPLANATION FOR ATTACHED DRAWING

FIG. 1 is the structural drawing of a capsule magnet pen tip.

FIG. 2 is the partial structural drawing of a magnet pen.

### PARTICULAR IMPLEMENTATION METHOD

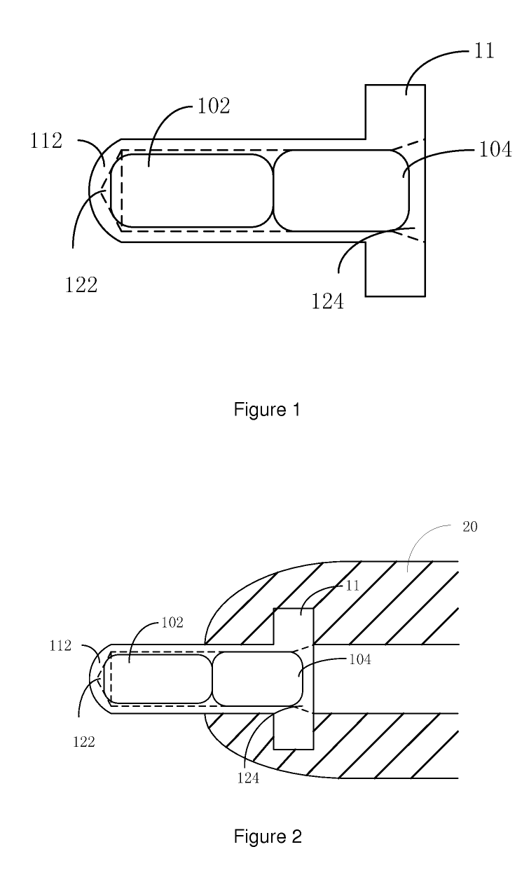

The present invention provides a capsule magnet pen tip device, wherein the magnet is assembled inside the cover. FIG. 1 is the structural drawing of a capsule magnet pen tip, comprising a cover 11, a magnet 102 and the seal of metal particle or silicone particle 104.

The exterior of the cover 11 of the pen tip 112 is curved, and the interior of the cover is cylindrical and hollow. That hollowed pen tip is conical 122, and the junction of the pen shaft 124 is processed with inverted triangle-shaped. The magnet 102 and the seal of metal particle or silicone particle 104 are placed inside the hollowed interior of the cover. The front of the sealed cover 11 acts as the pen tip and the seal of metal particle or silicone particle 104 is fit with the cover 11 and thus to force the magnet 102 stay at the front of the cover, i.e., the interior of the conical 122. The seal of metal particle or silicone particle 104 is mounted with the cover 11, allows the magnet 102 stay at the front of the cover and not be easily loosed. The magnet 102 and the seal of metal particle or silicone particle 104 are joined together as cylinder with inverted triangle-shaped process. The diameter of magnet 102 is shorter than the seal of the seal of metal particle or silicone particle. The cross-section surface of the cover 11 may be square, rectangle, triangle or others; and will be the same shape and size of the magnet 102 and the seal of metal particle or silicone particle 104. The material used for the cover 11 and the seal of particle, in this present invention is, Pb<40 ppm environmental copper or silicone cover or SUS304L stainless (Pb=0 ppm).

FIG. 2 is the partial structural drawing of a magnet pen. The cover of the pen tip 11 mounted with the trough of the pen shaft 20 very firmly and it will not be easily loosed.

The present invention provides a capsule magnet pen tip device, wherein the magnet is assembled inside the cover. The magnet and the seal of metal particle are located inside the cover and thus will not be easily loosed and swallowed by children. The use of lead-free or low-lead environmental material will avoid lead poisoning and pollution. The diameter of the magnet is shorter than the inner-diameter of the cover, wherein the magnet has contact with the part of the inverted triangle-shaped and the inner-cylinder of the cover only; so it is more protective of the magnet; and avoids damage of magnet from deformed cover. The semi-spherical pen tip reduces attrition with the drawing board, and also reduces the risk of poke to children. Thus, the present invention can greatly improve the safety of the article and protection of the environment as well as the value of the article.

The present invention provides a capsule magnet pen tip device, wherein the design, production and materials give great enhancement on the value of the article, and also its safety and standard of environmental protection.

The capsule magnet pen tip provided by the embodiment of the present invention is described in detail hereinbefore. As for the technical personnel generally skilled in the art, the embodiment and application scope may be changed to some extent according to the concept of the embodiment of the present invention. Therefore, the content of the specification does not set a limit on the present invention.

1. A capsule magnet pen tip comprises a magnet and a cover, characterized in that the magnet is assembled inside the cover.

2. The capsule magnet pen tip of claim 1, characterized in that it also comprises a seal of metal particle or silicone particle, wherein the seal of metal particle or silicone particle is located inside the cover. The front of the sealed cover acts as the pen tip and the seal of metal particle or silicone particle is fit with the cover and thus to force the magnet stay at the front of the cover.

3. The capsule magnet pen tip of claim 2, characterized in that the interior of the cover is cylindrical and hollow; wherein the magnet and the seal of metal particle or silicone particle are joined together as cylinder with inverted triangle-shaped process.

4. The capsule magnet pen tip of claim 3, characterized in that the front pen tip of the cover is conical.

5. The capsule magnet pen tip of claim 3, characterized in that the junction of the pen shaft and the cover is processed with inverted triangle-shaped.

6. The capsule magnet pen tip of claim 3, characterized in that the diameter of the magnet is shorter than the diameter of the seal of metal particle or silicone particle.

7. The capsule magnet pen tip of claim 1, characterized in that the exterior of the cover is curved.

8. Any of the capsule magnet pen tip of claim 1-7, characterized in that the material used for the cover is Pb<40 ppm environmental copper material or SUS304L stainless (Pb=0 ppm).

9. Any of the capsule magnet pen tip of claim 2-6, characterized in that the material used for the seal of particle is Pb<40 ppm environmental copper material or SUS304L stainless (Pb=0 ppm) metal or silicone.

10. A magnet pen, comprised with pen tip and shaft; characterized in that, the pen tip used is same as the capsule magnet pen tip of claim 1, wherein there is a trough inside the pen shaft to allow the pen tip mounted with.
